(19) United States
(12) Patent Application Publication
(10) Pub. No.: US 2008/0086515 A1
(43) Pub. Date: Apr. 10, 2008

(54) Method and System for a Soft Error Collection of Trace Files

(75) Inventors: Angqin Bai, Tucson, AZ (US); Jose Guillermo Miranda Gavillan, Tucson, AZ (US); Khanh V. Ngo, Tucson, AZ (US)

Correspondence Address: Frank C. Nicholas;CARDINAL LAW GROUP, Suite 2000, 1603 Orrington Avenue, Evanston, IL, 60201, US

(73) Assignee: International Business Machines Corporation, Armonk, NY (US)

(21) Appl. No.: 11/539,521

(22) Filed: Oct. 6, 2006

(51) Int. Cl. G06F 17/30

(52) U.S. Cl. 707/202

(57) ABSTRACT

A trace file collection system for implementing a trace file collection method for a soft error collection of one or more trace files associated with a data processing device. The method involves a periodic retrieval of an error log from the data processing device, a comparison of two or more retrieved error logs, and a retrieval of the trace file(s) from the data processing device based on the comparison of the two or more retrieved error logs indicating an occurrence of one or more soft errors within the data processing device.

### FIELD OF THE INVENTION

The present invention generally relates to a collection of trace files associated with a data processing device of any type having error logs (e.g., an automated data library). The present invention specifically relates to collecting trace files associated with a data processing device conditioned on the occurrence of soft errors within the data processing device.

### BACKGROUND OF THE INVENTION

Certain errors within an automated data library can go undetected, such as, for example, a get/put command may need a retry before succeeding, a get/put command fails on an accessor resulting in a switchover that successfully occurs on another accessor, or a the library detected matching drive serial numbers in its inventory. These “soft” errors are undetected because they do not cause a host job to fail. Although a soft error may posted on an operator-panel or indicated as a SNMP trap, current trace file collection techniques fail to be response to the occurrence of soft errors resulting in a trace file at the time of the soft error possibly being wrapped or overwritten, particularly in the library has limited trace file space. Additionally, if the trace file of the library is gathered at a later time, the trace file will not contain the actual error whereby the soft error could be debugged.

Some known solutions would be to increase a size space for trace files in a library, to add a hard drive to the library specifically for trace files, or to flash a trace file when any type of error occurs. However, drawbacks to these solutions are a physical increase in size space for the trace files only helps with newer or expandable data libraries and does not apply to existing data libraries that incapable of a physical increase in size, a logical increase in size will decrease the size space of “something else's size” and a flash of traces files for each error is impractical in terms of space and file management.

### SUMMARY OF THE INVENTION

The present invention provides a new and unique trace file collection system for a soft error collection of one or more traces files associated with a data processing device.

One form of the present invention is a computer readable medium tangibly embodying a program of machine-readable instructions executable by a processor to perform operations for the soft error collection of the trace file(s) associated with the data processing device. The operations comprise a periodic retrieval of an error log from the data processing device, a comparison of two or more retrieved error logs, and a retrieval of the trace file(s) from the data processing device based on the comparison of the two or more retrieved error logs indicating an occurrence of one or more soft errors within the data processing device.

A second form of the present invention is a trace file collection system comprising a processor; and a memory storing instructions operable with the processor for the soft error collection of the trace file(s) associated with the data processing device. The instructions are executed for periodically retrieving an error log from the data processing device, comparing two or more retrieved error logs, and retrieving the trace file(s) from the data processing device based on the comparison of the two or more retrieved error logs indicating an occurrence of one or more soft errors within the data processing device.

A third form of the present invention is a method for the soft error collection of the trace file(s) associated with the data processing device. The method comprises a periodic retrieval of an error log from the data processing device, a comparison of two or more retrieved error logs, and a retrieval of the trace file(s) from the data processing device based on the comparison of the two or more retrieved error logs indicating an occurrence of one or more soft errors within the data processing device.

The aforementioned forms and additional forms as well as objects and advantages of the present invention will become further apparent from the following detailed description of the various embodiments of the present invention read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates a general embodiment of a trace file collector in accordance with the present invention;

FIG. 2 illustrates a flowchart representative of a general embodiment of a trace file collection method in accordance with the present invention;

FIG. 3 illustrates an exemplary collection of trace files by the trace file collector illustrated in FIG. 1 in accordance with the trace file collection method illustrated in FIG. 2;

FIG. 4 illustrates one embodiment of the trace file collector illustrated in FIG. 1 in accordance with the present invention;

FIG. 5 illustrates a flowchart representative of one embodiment of the trace file collection method illustrated in FIG. 3 in accordance with the present invention;

FIG. 6 illustrates an exemplary parsing of error logs by the trace file collector illustrated in FIG. 4 in accordance with the trace file collection method illustrated in FIG. 5; and

FIG. 7 illustrates an exemplary collection of trace files by the trace file collector illustrated in FIG. 4 in accordance with the trace file collection method illustrated in FIG. 5.

### DETAILED DESCRIPTION OF THE PRESENT INVENTION

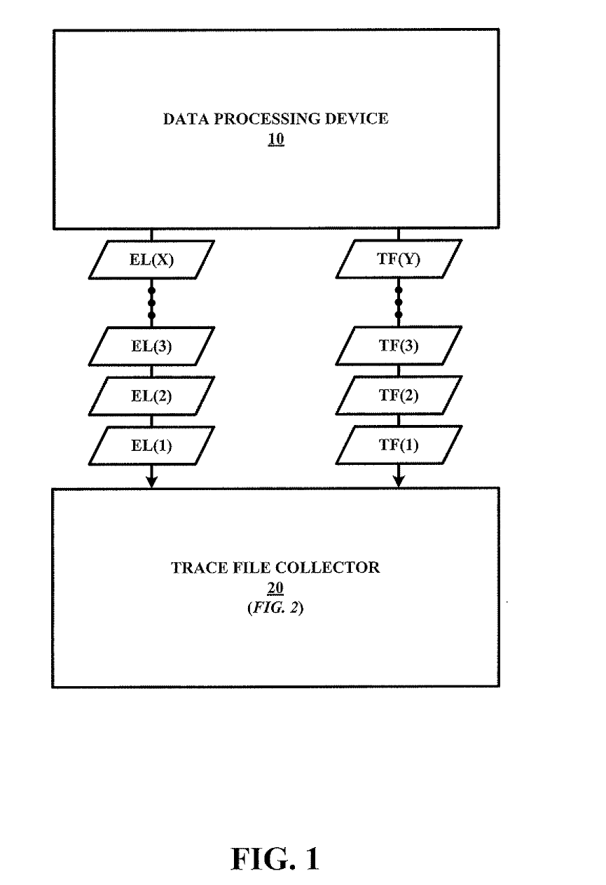

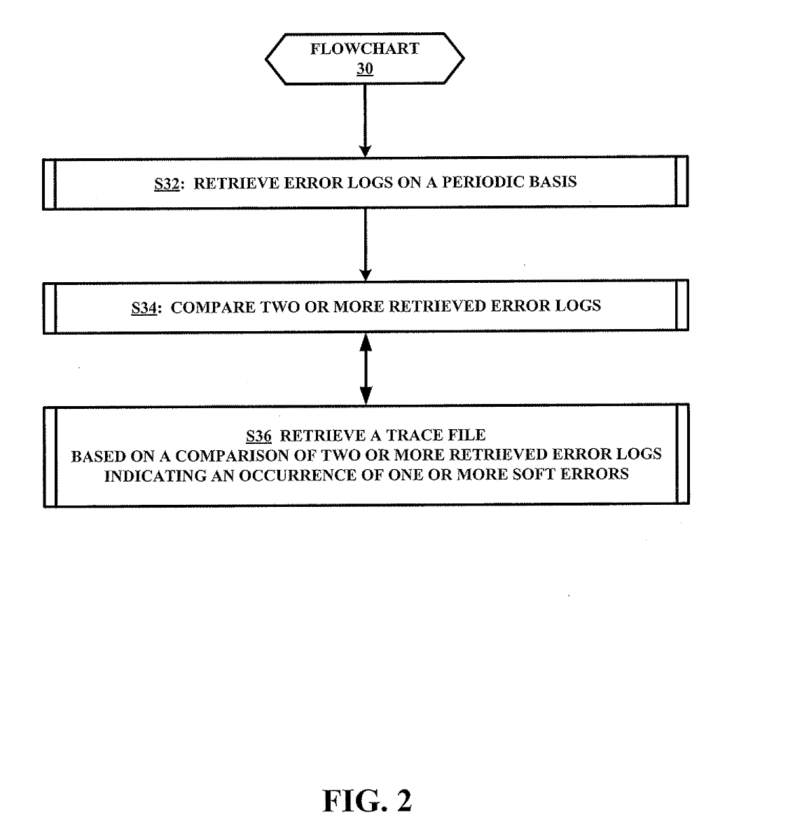

FIG. 1 illustrates a trace file collector 20 of the present invention structurally configured to collect a Y number of trace files TF of a data processing device 10, where Y≧0, conditioned on soft errors of data processing device 10 contained with an X number of error logs EL retrieved from data processing device 10, where X≧2. Specifically, trace file collector 20 implements a trace file collection method of the present invention represented by a flowchart 30 illustrated in FIG. 2.

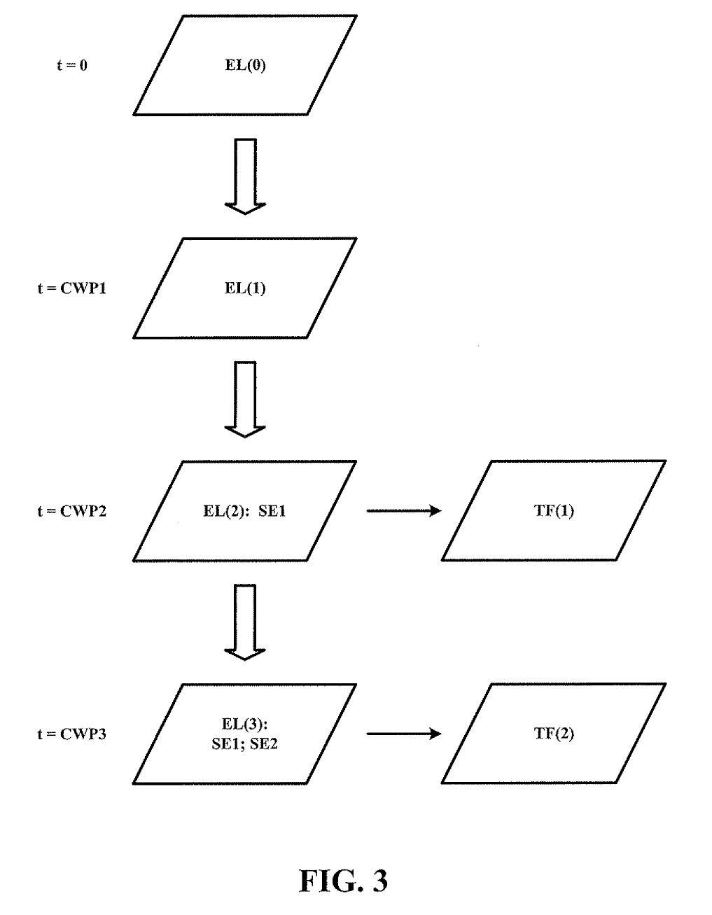

Referring to FIG. 2, a stage S32 of flowchart 30 encompasses trace file collector 20 periodically retrieving an error log from data processing device 10. For example, as illustrated in FIG. 3, the retrieval of an initial error log EL(0) from data processing device 10 by trace file collector 20 at t=0 is followed by a retrieval of error logs EL(1)-EL(3) from data processing device 10 by trace file collector 20 upon an expiration of three (3) respective collection wait periods CWP1-CWP3.

With each retrieval of an error log from data processing device 10 by trace file collector 20 after an expiration of a collection wait period, trace file collector 20 compares two or more of the retrieved error logs during a stage S34 of flowchart 30 to thereby conditionally retrieve a trace file from data processing device 10 during a stage S36 of flowchart 30. For example, as illustrated in FIG. 3, an execution of stage S34 upon expiration of collection wait period CWP1 involves a comparison of error logs EL(0) and EL(1) that results in trace file collector 20 deciding not to retrieve a current trace file from data processing device 10 based on the comparison of error logs EL(0) and EL(1) failing to indicate an occurrence of a soft error within data processing device 10. By further example, an execution of stage S34 upon expiration of collection wait period CWP2 involves a comparison of error logs EL(0) and/or EL(1) to EL(2) that results in trace file collector 20 deciding to retrieve a current trace file TF1 from data processing device 10 based on the comparison of error logs EL(0) and/or EL(1) to EL(2) indicating an occurrence of a soft error SE1 within data processing device 10. Also by example, an execution of stage S34 upon expiration of collection wait period CWP3 involves a comparison of error logs EL(0), EL(1) and/or EL(2) to EL(3) that results in trace file collector 20 deciding to retrieve a current trace file TF2 from data processing device 10 based on the comparison of error logs EL(0), EL(1) and/or EL(2) to EL(3) indicating an occurrence of a soft error SE2 within data processing device 10.

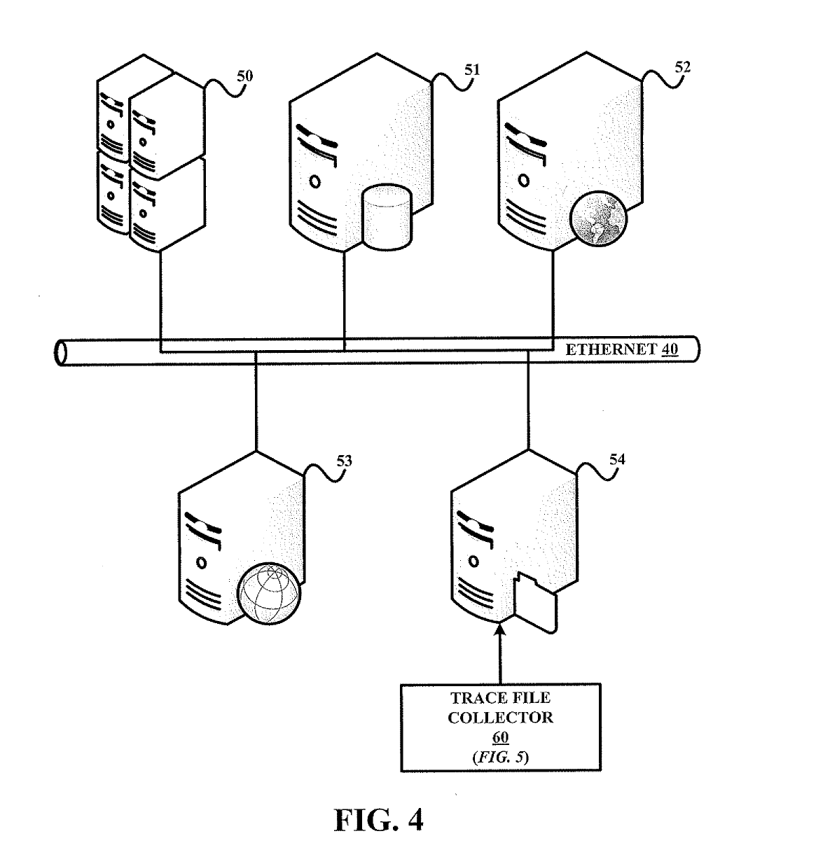

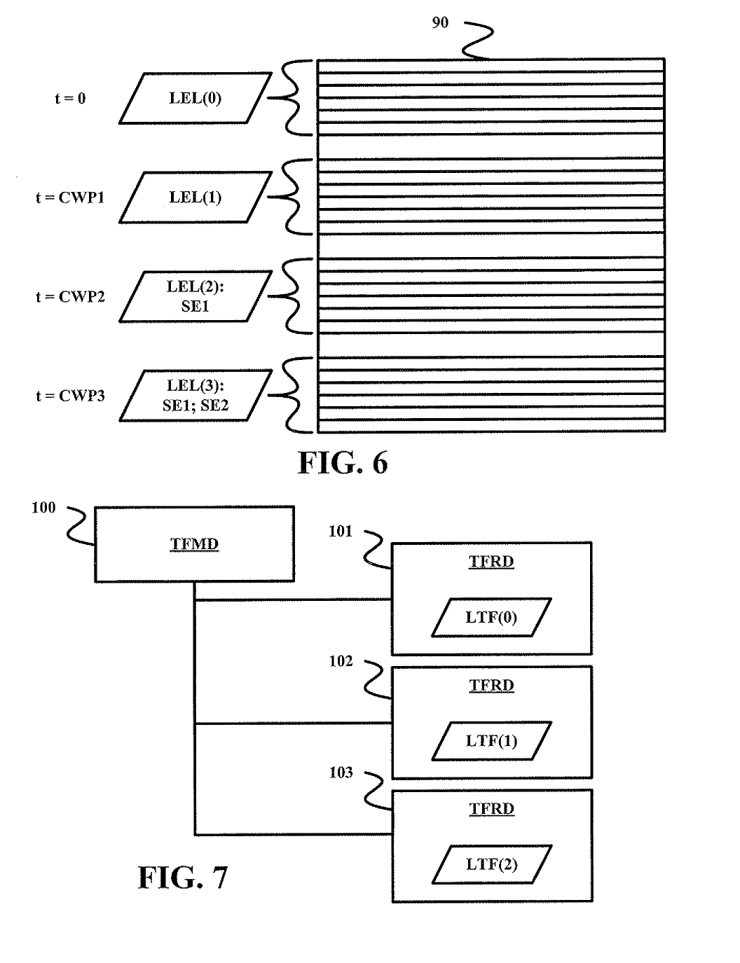

In practice, the present invention does not impose any limitations or any restrictions as to a manner by which the trace collection method illustrated in FIG. 2 is implemented. Nonetheless, to further illustrate an understanding of the inventive principles of present invention, FIG. 4 illustrates an exemplary Ethernet 40 for practicing a trace collection method of the present invention represented by a flowchart 70 as illustrated in FIG. 6.

Specifically, FIG. 4 illustrates Ethernet 40 interconnecting an application server 50, a database server 51, a web server 52, an automated tape library 53 and a trace file management server 54. Automated tape library 53 stores data generated by workstations (not shown) connected to Ethernet 40 for purposes of utilizing servers 50-52. A trace file collector 60 in the form of a software module is installed in a memory of trace file management server 54 for purposes of a processor of trace file management server 54 executing flowchart 70 as embodied in trace file collector 60. To facilitate an understanding of trace file collector 60, flowchart 70 will now be described herein in the context of retrieving four (4) library error logs LEL(0)-LEL(3).

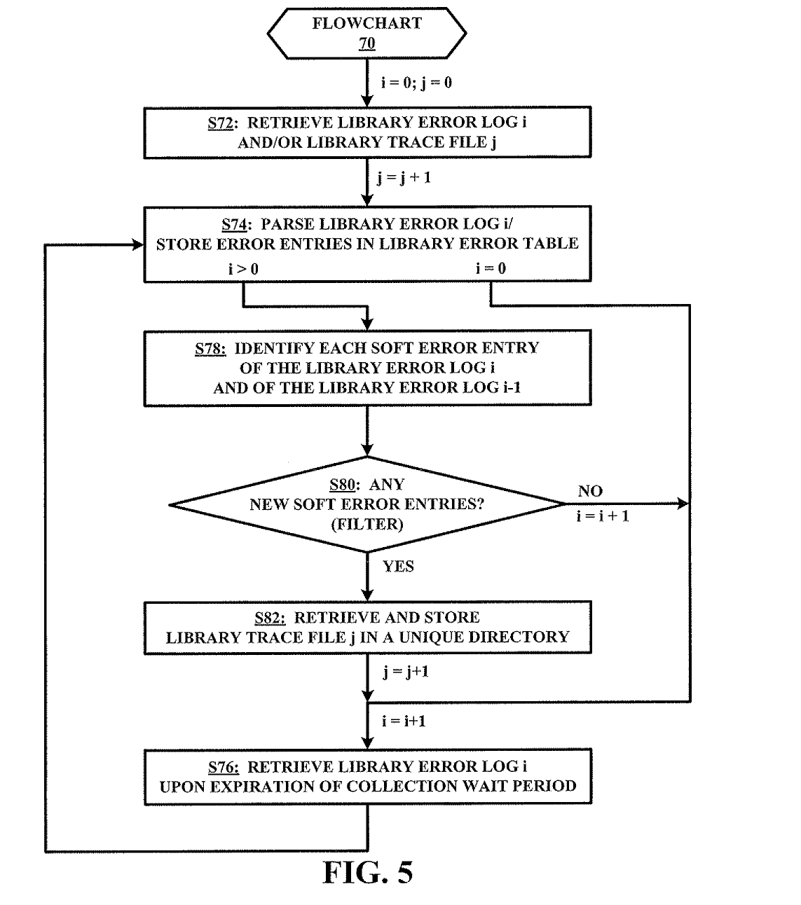

Referring to FIG. 5, a stage S72 of flowchart 70 encompasses server 54 retrieving a library error log LEL(0) and a library trace file LTF(0) from library 53. Library error log LEL(0) is retrieved to serve as the initial basis for a conditional retrieval of additional trace files from library 53 as will be subsequently described herein. Library trace file LTF(0) is retrieved to identify any soft errors within library 10 upon an initial startup of server 54, which maybe subsequent to a startup of library 53. Library trace file LTF(0) is stored within a unique trace file directory if library trace file LTF(0) contains any soft errors, and can be stored within a unique trace file directory if library trace file LTF(0) does not contain any soft errors. In this case, library error log LEL(0) does not contain any soft errors as illustrated in FIG. 6, yet library trace file LTF(0) is stored within a trace file retrieval directory (“TFRD”) 101 of a trace file management directory 100 as illustrated in FIG. 7.

A stage S74 of flowchart 70 encompasses server 54 parsing library error log LEL(0) and storing its error entries in a library error table 90 as illustrated in FIG. 6. In view of library error log LEL(0) being the initial error log retrieved from library 53, server 54 thereafter proceeds to a stage S76 of flowchart 70 to await an expiration of a collection wait period CWP1 (e.g., five minutes). Upon an expiration of collection wait period CWP1, server 54 retrieves library error log LEL(1) from library 53 during stage S74 whereby server 54 parses library error log LEL(1) and stores its error entries in library error table 90 as illustrated in FIG. 6.

In view of library error log LEL(1) being an additional error log retrieved from library 53, server 54 proceeds to a stage S78 of flowchart 70 to identify each soft error entry of library error logs LEL(0) and LEL(1) to thereby determine during a stage S80 of flowchart 70 whether any new soft errors occurred within library 53 between the retrievals of library error logs LEL(0) and LEL(1) from library 53. In this case, zero (0) soft errors occurred within library 53 between the retrievals of library error logs LEL(0) and LEL(1) from library 53, and server 54 therefore proceeds to stage S76 to await an expiration of a collection wait period CWP2 (e.g., five minutes). Upon an expiration of collection wait period CWP2, server 54 retrieves library error log LEL(2) from library 53 during stage S74 whereby server 54 parses library error log LEL(2) and stores its error entries in library error table 90 as illustrated in FIG. 6.

In view of library error log LEL(2) being an additional error log retrieved from library 53, server 54 proceeds to stage S78 to identify each soft error entry of library error logs LEL(1) and LEL(2) to thereby determine during stage S80 whether any new soft errors occurred within library 53 between the retrievals of library error logs LEL(1) and LEL(2) from library 53. In this case, one (1) soft error SE1 occurred within library 53 between the retrievals of library error logs LEL(1) and LEL(2) from library 53, and server 54 therefore proceeds to a stage S82 of flowchart 80 to retrieve and store a library trace file LTF(1) within a trace file retrieval directory (“TFRD”) 102 of trace file management directory 100 as illustrated in FIG. 7 and then to stage S76 to await an expiration of a collection wait period CWP3 (e.g., five minutes). Upon an expiration of collection wait period CWP3, server 54 retrieves library error log LEL(3) from library 53 during stage S74 whereby server 54 parses library error log LEL(3) and stores its error entries in library error table 90 as illustrated in FIG. 6.

In view of library error log LEL(3) being an additional error log retrieved from library 53, server 54 proceeds to stage S78 to identify each soft error entry of library error logs LEL(2) and LEL(3) to thereby determine during stage S80 whether any new soft errors occurred within library 53 between the retrievals of library error logs LEL(2) and LEL(3) from library 53. In this case, one (1) soft error SE2 occurred within library 53 between the retrievals of library error logs LEL(2) and LEL(3) from library 53, and server 54 therefore proceeds to stage S82 to retrieve and store a library trace file LTF(2) within a trace file retrieval directory (“TFRD”) 103 of trace file management directory 100 as illustrated in FIG. 7. At this point, if flowchart 70 was terminated by server 50 due to a hard error occurring within library 53 or some other viable reason, then three (3) library trace files LTF(0)-LTF(2) would be conveniently stored within server 50 for debugging purposes.

Referring to FIGS. 1-7, those having ordinary skill in the art will appreciate various benefits and advantages of the present invention, including, but not limited to, a historic collection of trace files containing each soft error occurring within a data processing device during the retrieval of error logs in a non-interruptive manner to the data processing device, an elimination of any need to upgrade or install software code within a data processing device previously configured for allowing a retrieval of error logs and traces files by an external device, and a simple installment of a trace file collector of the present invention within an Ethernet server or workstation.

The term “processor” as used herein is broadly defined as one or more processing units of any type for performing all arithmetic and logical operations and for decoding and executing all instructions related to facilitating an implementation by a trace file collection system of the various trace file collection methods of the present invention. Additionally, the term “memory” as used herein is broadly defined as encompassing all storage space in the form of computer readable mediums of any type within a trace file collection system of the present invention, particularly computer readable mediums embodying a program of machine-readable instructions executable by the processor.

Referring to FIG. 5, the present invention does not impose any limitations nor any restrictions as to the basis of the collection wait period. As described in connection with FIG. 7, the collection wait period can be a time-based period, such as, for example, a fixed or variable time period. Alternatively or concurrently, the collection wait period can be an event-based period, such as, for example, a comparison of an activity level of the library as indicated by the retrieval of additional log files as would be appreciated by those having ordinary skill in the art in relation to an activity threshold indicative of a predetermined activity level for triggering the retrieval of the next error log.

Again referring to FIG. 5, stage 80 can be implemented with an application of a filter for purposes of filtering through only those soft error entries that are deemed to be necessary or required for triggering a retrieval of the next error log during stage S82 in accordance with a trace file collection policy. For example, if a library has multiple partitions and the trace file collection policy specifies soft errors of a particular one of the partitions as being the trigger for the retrieval of the next error log during stage S82, then the filter would be designed to pass through soft error entries from that particular partition and to block soft error entries from the other partitions. Also by example, the trace file collection policy may specify that soft errors related to hardware known to be missing from the library for whatever reason must be blocked by the filter.

Furthermore, those having ordinary skill in the art of trace file collection techniques may develop other embodiments of the present invention in view of the inventive principles of the present invention described herein. Thus, the terms and expression which have been employed in the foregoing specification are used herein as terms of description and not of limitations, and there is no intention in the use of such terms and expressions of excluding equivalents of the features shown and described or portions thereof, it being recognized that the scope of the present invention is defined and limited only by the claims which follow.

We claim:

1. A computer bearing medium tangibly embodying a program of machine-readable instructions executable by a processor to perform operations for a soft error collection of at least one trace file associated with a data processing device, the operations comprising:
periodically retrieving an error log from the data processing device;
comparing at least two retrieved error logs; and
retrieving the at least one trace file from the data processing device based on the comparison of the at least two retrieved error logs indicating an occurrence of at least one soft error within the data processing device.

2. The computer bearing medium of claim 1, wherein the data processing device is an automated tape library.

3. The computer bearing medium of claim 1, wherein the operations further comprise:
storing each retrieved error log within an error log table.

4. The computer bearing medium of claim 1, wherein the comparing of at least two retrieved error logs includes:
identifying each software error entry of a currently retrieved error log absent from a previously retrieved error log.

5. The computer bearing medium of claim 4, wherein the comparing of at least two retrieved error logs further includes:
applying a filter to each identified software error entry.

6. The computer bearing medium of claim 5, wherein a trace file is retrieved in response to at least one identified software error entry passing through the filter.

7. The computer bearing medium of claim 1, wherein the operations further comprise:
storing each retrieved trace file in a unique file directory.

8. A trace file collection system, comprising:
a processor; and
a memory storing instructions operable with the processor for a soft error collection of at least one trace file associated with a data processing device, the instructions are executed for:
periodically retrieving an error log from the data processing device;
comparing at least two retrieved error logs; and
retrieving the at least one trace file from the data processing device based on the comparison of the at least two retrieved error logs indicating an occurrence of at least one soft error within the data processing device.

9. The trace file collection system of claim 8, wherein the data processing device is an automated tape library.

10. The trace file collection system of claim 8, wherein the instructions are further executed for:
storing each retrieved error log within an error log table.

11. The trace file collection system of claim 8, wherein the comparing of the at least two retrieved error logs includes:
identifying each software error entry of a currently retrieved error log absent from a previously retrieved error log.

12. The trace file collection system of claim 11, wherein the comparing of the at least two retrieved error logs further includes:
applying a filter to each identified software error entry.

13. The trace file collection system of claim 12, wherein a trace file is retrieved in response to at least one identified software error entry passing through the filter.

14. The trace file collection system of claim 8, wherein the instructions are further executed for:
storing each retrieved trace file in a unique file directory.

15. A trace file collection method for a soft error collection of at least one trace file associated with a data processing device, the method comprising:
periodically retrieving an error log from the data processing device;
comparing at least two retrieved error logs; and
retrieving the at least one trace file from the data processing device based on the comparison of the at least two retrieved error logs indicating an occurrence of at least one soft error within the data processing device.

16. The trace file collection method of claim 15, wherein the data processing device is an automated tape library.

17. The trace file collection method of claim 15, further comprising:
storing each retrieved error log within an error log table.

18. The trace file collection method of claim 15, wherein the comparing of the at least two retrieved error logs includes:
identifying each software error entry of a currently retrieved error log absent from a previously retrieved error log.

19. The trace file collection method of claim 18, wherein the comparing of the at least two retrieved error logs further includes:
applying a filter to each identified software error entry.

20. The trace file collection method of claim 19, wherein a trace file is retrieved in response to at least one identified software error entry passing through the filter.

21. The trace file collection method of claim 15, wherein the instructions are further executed for:
storing each retrieved trace file in a unique file directory.
